(19) United States
(12) Patent Application Publication
(10) Pub. No.: US 2018/0083990 A1
(43) Pub. Date: Mar. 22, 2018

(54) Network Security Device and Application

(71) Applicant: John Richard Abe, San Jose, CA (US)

(72) Inventor: John Richard Abe, San Jose, CA (US)

(21) Appl. No.: 14/691,017

(22) Filed: Apr. 20, 2015

(51) Int. Cl. H04L 29/06

(52) U.S. Cl. CPC H04L 63/1425

(57) ABSTRACT

The present invention passively monitors computer network traffic to determine when a potential network attack is underway. The system, method and computer program product initiates the process using a learning mode that identifies unique source and destination Internet Protocol (IP) address pairs. Then the frequency of these the IP pairs are computed for multiple periods. In the analyze mode, the frequency for each IP pair is statistically analyzed and a threshold set based on rules. In the run mode, the frequency of IP pairs are computed and compared to the thresholds. If a threshold is crossed, an alert is generated that a network administrator or other user can react to.

### FIELD OF INVENTION

The present invention is the technical field of network security. More particularly, the invention is the technical field of detecting computer network attacks.

### BACKGROUND OF INVENTION

Security applications and devices have been developed to mitigate the threat of unintended user access to a network's stored information. These devices attempt to block access by creating network barriers to unauthorized access as well as a means of detecting hostile software, known as malware, designed to aid an unintended user gain access to stored information or in some other way compromise the network. Malware is detected by scanning data stores, emails, and downloaded files for known signatures of malware. Once detected, the malware is automatically eliminated or quarantined.

A malware's signature is a unique identifier associated with the code sequence of known malware. Security devices and applications scan files for these unique signatures and take appropriate action if a file containing malware is detected. These devices and applications are used worldwide to protect computers, networks and files from access by unintended users.

The efficacy of prior art security devices and applications depend on knowing the signature of malware. Numerous companies make their business by selling devices, applications, and determining the signature of malware. Of coarse, if the signature is not yet known, as is often the case in a sophisticated network attack, the security devices and applications employing this technique are rendered useless against the attack.

Furthermore, existing virus detection products are useless in detecting disgruntled employees or other individuals who are pirating intellectual or other valuable property via the network. Not only is there no malware signature, no malware is involved in the theft, just the individual behind the attack.

### SUMMARY OF INVENTION

A computer implemented method, system, and computer program product that are provided for learning the behavior of network communications and generating alerts based on detected network behavior. A reaction may then be carried out based on the alerts.

The invention monitors the frequency and quantity of data exchange for source and destination IP address pairs in a time period to identify potential threats. In one aspect, the invention is a computer program product embodied on a computer readable medium for utilizing network activity. The product comprises computer code for monitoring computer network traffic activity, via a connection to the computer network, utilizing a processor of a computer system, wherein the frequency and amount of data exchange of source and destination Internet Protocol address pairs are recorded by time interval, computer code for generating alerts based on frequency threshold crossings for specific source and destination Internet Protocol addresses, and computer code for generating alerts based on the amount threshold crossing for the quantity of data associated with each specific source and destination Internet Protocol address.

In another aspect the invention is a system for utilizing a frequency and amount of data exchanged of source and destination internet Protocol address pairs. The system comprises a processor for monitoring Internet Protocol traffic on a network via a network connection, calculating a frequency and aggregated data exchanged for specific source and destination internet Protocol address pairs, setting a frequency and data volume thresholds for specific source and destination Internet Protocol address pairs by time period and generating alerts when the frequency or data volume crosses their respective thresholds. The frequency and aggregate data exchanged of source and destination Internet Protocol addresses are used to estimate the behavior in computer to computer communications. It may be used to compute a frequency distribution or a data volume distribution of computer to computer communications, or to calculate an expected probability of frequency or data exchange in a given period which can be used to determine the frequency threshold and the data threshold for a specific source and destination Internet Protocol address. An alert is generated when the frequency threshold or data threshold is exceeded by the observed frequency for a specific source and destination Internet Protocol address. Other alerts may also be provided and user alerts maybe sent based on aggregated alerts.

The foregoing was intended as a summary only and of only some of the aspects of the invention. It was not intended to define the limits or requirements of the invention. Other aspects of the invention will be appreciated by reference to the detailed description of the preferred embodiments. Moreover, this summary should be read as though the claims were incorporated herein for completeness.

### BRIEF DESCRIPTION OF THE DRAWINGS

FIG. 1 is a network diagram showing the relationship of the Security Device and Application to network elements

FIG. 2 is a diagram of a general purpose computer processor and the principal elements used in one embodiment.

FIG. 3 is a flow diagram of the software application's major components.

FIG. 4 is the first flow chart of Thread 2 (Sniff), the logical steps for sniffing network activity. Sniff is a term of the art to describe the monitoring of network packets.

FIG. 5 is the second and final flow chart of Thread 2 (Sniff), the logical steps for sniffing network activity.

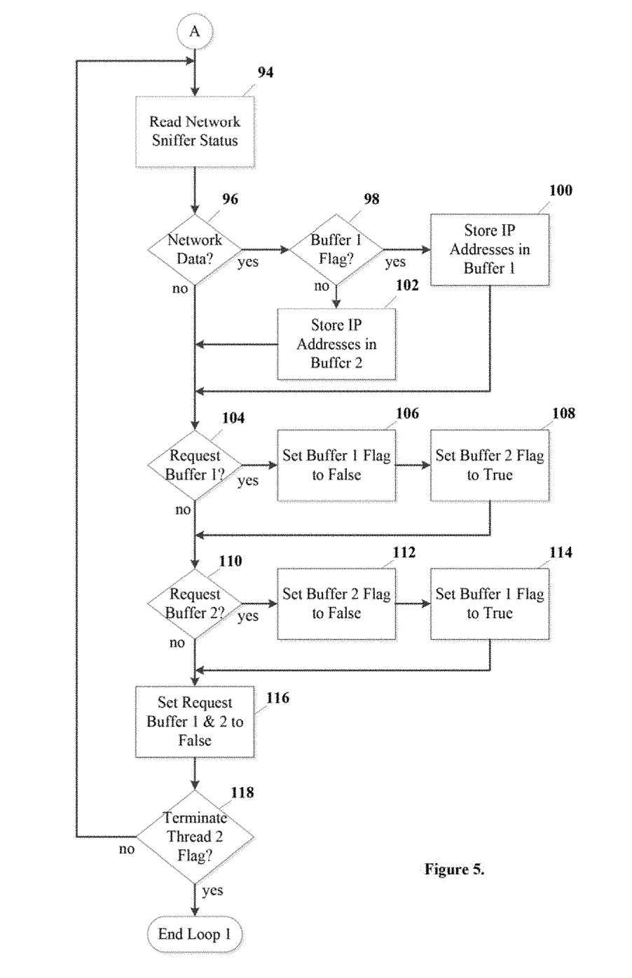

FIG. 6 is the first flow chart of Thread 3 (Collect), the logical steps for collecting and storing Internet Protocol source and destination address pairs.

FIG. 7 is the second flow chart of Thread 3 (Collect), the logical steps for collecting and storing Internet Protocol source and destination address pairs.

FIG. 8 is the final flow chart of Thread 3 (Collect), the code collecting and storing Internet Protocol source/destination address pairs.

FIG. 9 is a diagram of the binary tree data structure.

FIG. 10 is a diagram of a data structure container element.

FIG. 11 is a first flow chart of Thread 4 (Analyze), the logical steps for analyzing the frequency distributions of Internet Protocol source/destination address pairs.

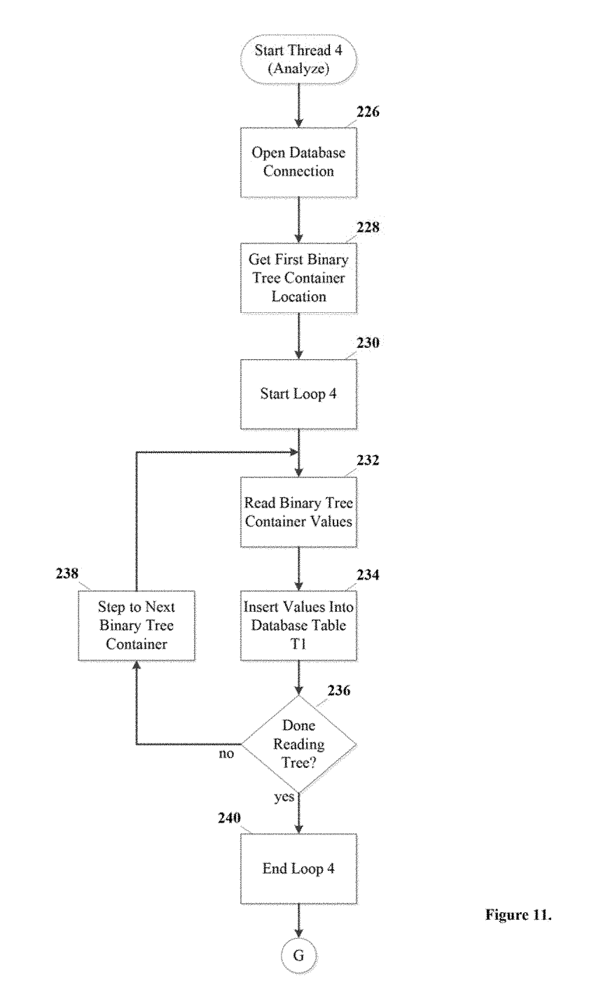

FIG. 12 is a second flow chart of Thread 4 (Analyze), the logical steps for analyzing the frequency distributions of Internet Protocol source/destination address pairs.

FIG. 13 is a final flow chart of Thread 4 (Analyze), the logical steps for analyzing the frequency distributions of Internet Protocol source/destination address pairs.

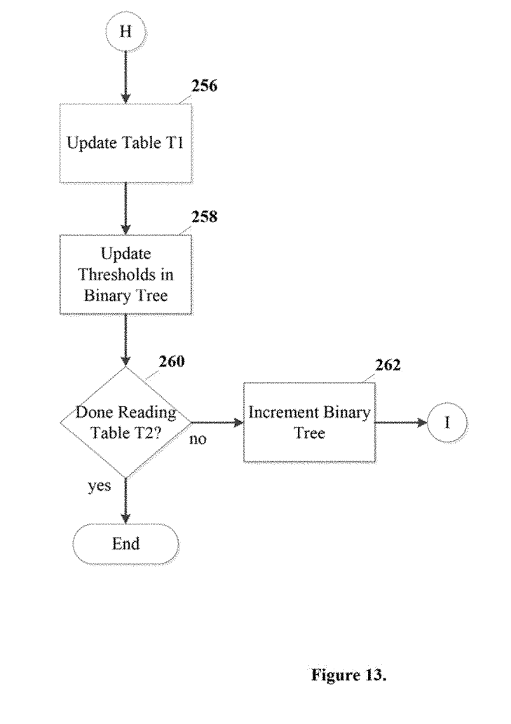

FIG. 14 is a first flow chart of Thread 5 (Alert), the logical steps for creating alerts when the frequency distributions exceed a threshold.

FIG. 15 is a second flow chart of Thread 5 (Alert), the logical steps for creating alerts when the frequency distributions exceed a threshold.

FIG. 16 is a final flow chart of Thread 5 (Alert), the logical, steps for creating alerts when the frequency distributions exceed a threshold.

### DETAILED DESCRIPTION OF THE DRAWINGS

The following description is presented to enable one of ordinary skill in the art to make and use the present embodiment. Various modifications to the illustrated embodiment will be readily apparent to those skilled in the art and the generic principles herein may be applied to other embodiments. Thus, the present embodiment is not intended to be limited to the embodiment shown, but is to be accorded the widest possible scope consistent with the principles and features described herein.

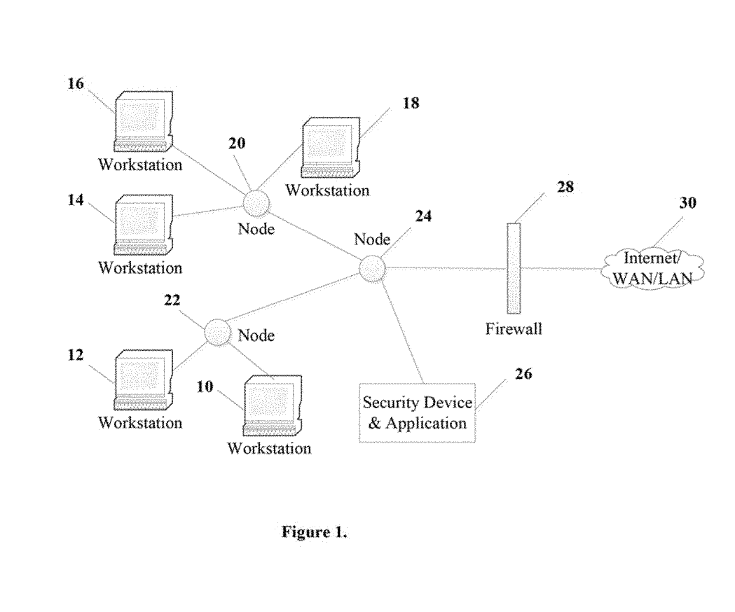

As shown in FIG. 1, the Security Device and Application 26, referred to as SDA, resides on a node 26 on a computer network. The network consists of workstations 10, 12, 14, 16, 18, and nodes 20, 22, 24, a firewall 28, and a connection to the Internet/WAN/LAN 30.

Alternative embodiments include other network topologies. These topologies may or may not include firewalls, Internet access, switches, or routers.

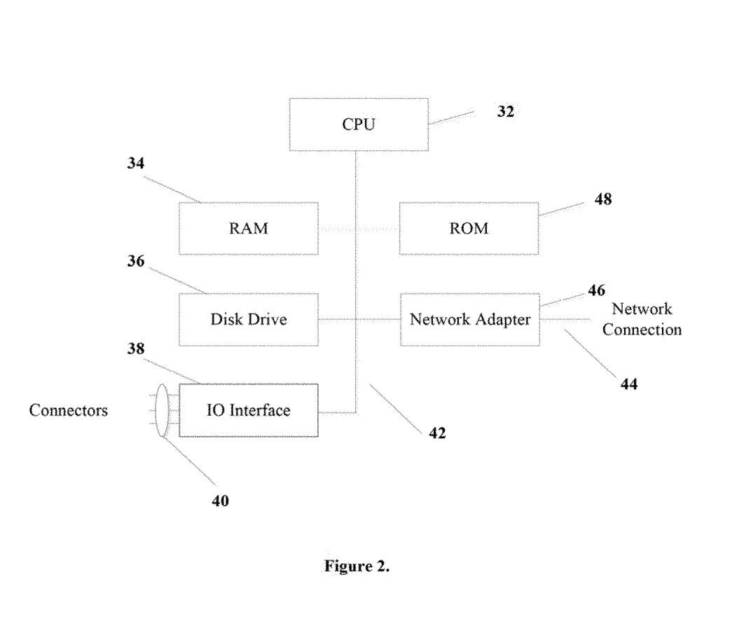

A diagram of the SDA is shown in FIG. 2. The SDA is comprised of a CPU 32, Random Access Memory (RAM) 34, one or more disk drives that may be mechanical, or solid state 36, Input/Output (IO) 40, Read Only Memory (ROM) 48, and a network adapter 46, and a network connection 44.

Other embodiments include sequential state machines or a combination of a sequential state machine and a CPU.

In an embodiment, CPU 32 retrieves a startup program from the ROM 48 when power is applied. The software application associated with the security device is then retrieved from disk 36 and executes in RAM 34. The network adapter 46 retrieves network data through a network connection 44.

Alternative embodiments may include different mechanisms to retrieve network data other than a network adapter. These alternatives may include previously recorded network data stored on a thumb drive or other types of media.

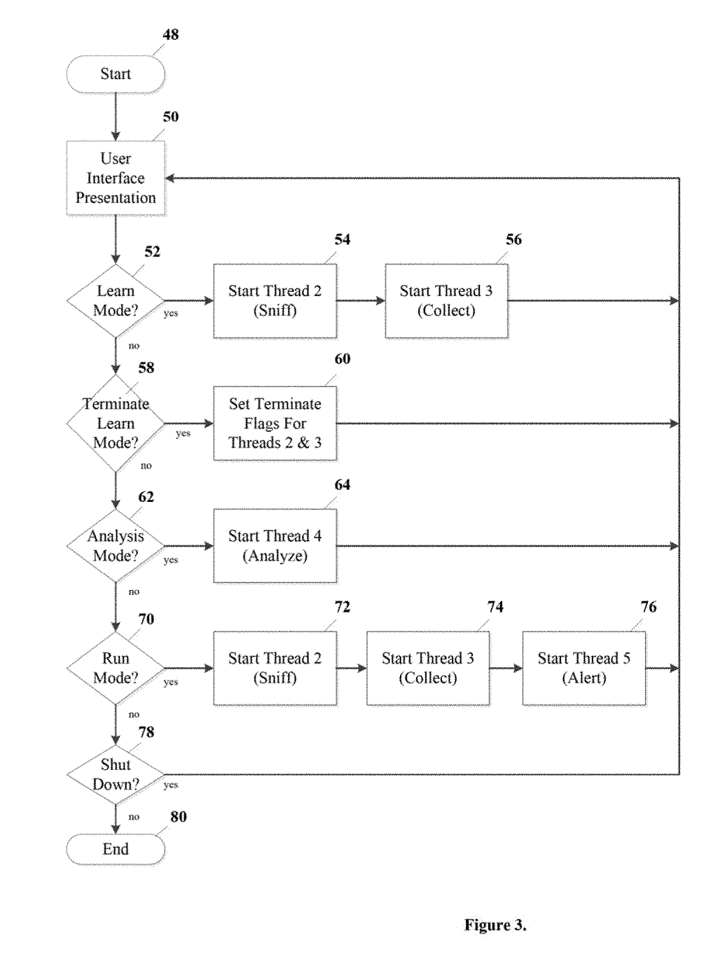

The diagram of the software portion of the SDA is shown in FIG. 3. The logical steps beginning with Start 48 are shown. The User Interface Presentation 50 presents a user display with a variety of modes which include; Learn Mode 52, Terminate Mode 58, Analysis Mode 62, Set Threshold Mode 66, Run Mode 70, and Shut Down 78. The user can select various modes from the display. Once a mode is selected from the display, the mode is executed when the selected mode is matched to its respective decision; Learn Mode 52, Terminate Mode 58, Analysis Mode 62, Set Threshold Mode 66, Run Mode 70, and Shut Down 78.

If the Learn Mode 52 is selected by the user, two threads are initiated through the Start Thread 2 (Sniff) and the Start Thread 3 (Collect). In an embodiment, Start Thread 2 (Sniff) and the Start Thread 3 (Collect) run concurrently, but in alternate embodiments can be non-concurrent. The program then returns to the User Interface Presentation 50.

If the Terminate Learn Mode 58 is selected by the user, a Set Terminate Flags For Threads 2 and 3 60 is invoked. The program then returns to the User Interface Presentation 50.

If the Analysis Mode 62 is selected by the user, the system runs Start Thread 4 (Analyze) 64. The program then returns to the User Interface Presentation 50.

If the Set Threshold Mode 66 is selected by the user, the Start Thread 5 (Set Threshold) 68 is invoked. The program then returns to the User Interface 50.

If the Run Mode 70 is selected by the user, then three concurrent threads are started; Start Thread 2 (Sniff) 72, Stan Thread 3 (Collect) 74, and Start Thread 5 (Alert) 76. The program then returns to the User Interface Presentation 50.

If the Shut Down Mode 78 is selected by the user, the program ends 80, otherwise the program returns to the User interface Presentation 50.

An alternative embodiment of the SDA may include an implementation without a User Interface Presentation 50. In this embodiment, a configuration file is used to set the various modes of the SDA. The SDA can periodically read the configuration file to determine if a new mode has been set by a means external to the SDA such as another program.

In yet another embodiment, components of the SDA, namely the components designated as Threads 54, 56, 64, 68, 76 can be invoked by another program.

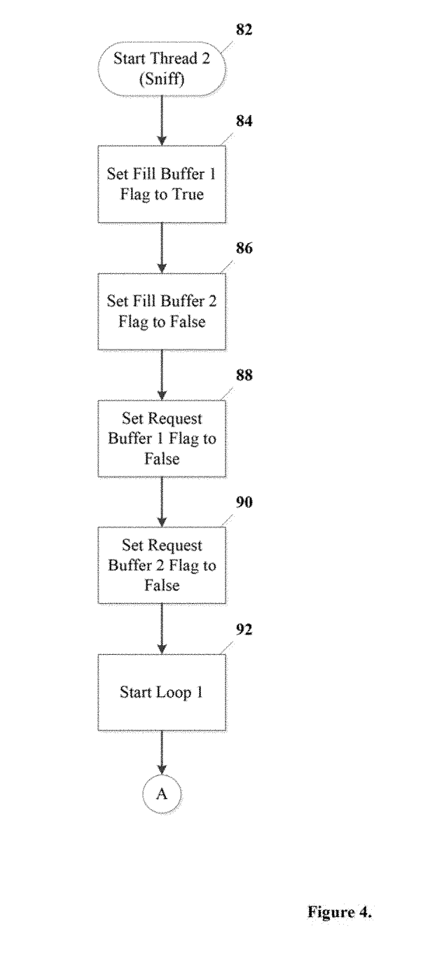

FIG. 4 shows the logical flow of Thread 2 (Sniff) beginning with Start Thread 2 (Sniff) 82. Thread 2 is a set of instructions responsible for collecting network data. Two buffers alternate between collecting network data and unloading data for analysis. As a buffer is filling, the alternate buffer is being unloaded for analysis. Once the buffer is unloaded, the buffers switch roles and the buffer previously used for analysis is used for collection while the alternate buffer is used for analysis.

The Set Fill Buffer 1 Flag is set to true 84, the Set Fill Buffer 2 Flag is set to toe 86, the Set Request Buffer 1 Flag is set to false 88, and the Set Request Buffer 2 Flag is set to false 90. A true flag for the Set Fill Buffer Flag indicates that the respective buffer is to be filled. A true for the Set Request Buffer Flag indicates a request from another SDA thread that the respective buffer is to be read. The Request Buffer Flag indicates Buffer 1 and Buffer 2 alternately used to store network data. While Buffer 1 is storing network data, Buffer 2 is being read, and vice-versa. The setting of Buffer 1 Flag to true 84, causes Buffer 1 to fill, while the setting of Buffer 2 Flag 86 to false causes the reading of Buffer 2.

Loop 1 92 is initiated, which consists of steps to read the network sniffer module, determine if data is present, and then write the data to either Buffer 1 or Butler 2. Before Loop 1 repeats, a check of the Terminate Thread 2 Flag is made 118 to determine if Loop 1 should complete.

Once Loop 1 is initiated, the Read Network Sniffer Status 94 is executed as shown in FIG. 4. A decision at Network Data 96 is made as to whether network data is available. If Internet Protocol packet data is present, Buffer 1 Flag 98 is set, then the Internet Protocol source and destination address pairs are stored in the step Store IP Address in Buffer 1 100.

If Buffer 1 Flag 98 is not set, then the Internet Protocol source and destination address pairs are stored in Buffer 2 using the Store IP Addresses in Buffer 2 102 step. The program then proceeds to the conditional branch of Request Buffer 1 104 step.

If at the Network Data 96 step, no data is present, the program proceeds to the conditional branch of Request Buffer 1 104 step.

At the conditional branch step of Request Buffer 1 104, the request buffer 1 flag is evaluated. If the flag is set, the program proceeds to Set Buffer 1. Flag to False 106 and then Set Buffer 2 Flag to True 108. The program proceeds to the conditional branch of Request Buffer 2 110.

If the at the conditional branch step of Request Buffer 1 104, the request buffer 1 flag is not set, the program proceeds to the to the conditional branch step Request Buffer 2 110.

The conditional branch, Request Buffer 2 110 determines whether the request buffer 2 flag is true, and if so, proceeds to the Set Buffer 2 Flag to False 112 step and then to the Set Buffer 1 Flag to True 114 step, before proceeding to the Set Request Buffer 1 & 2 to False step 116.

If the conditional branch, Request Buffer 2 110 step is false, then the program proceeds to the Set Request Buffer 1 & 2 to False 116 step.

The Set Request Buffer 1 & 2 to False 116 step sets the request buffer 1 and 2 flags to false.

Next, the Terminate Thread 2 Flag 118 is checked. If the terminate flag is not set, then the program loop 1 is repeated executing Read Network Sniffer Status 94 and the subsequent steps. If the terminate flag is set, then, thread 1 ends and control is returned to the point Thread 2 was called.

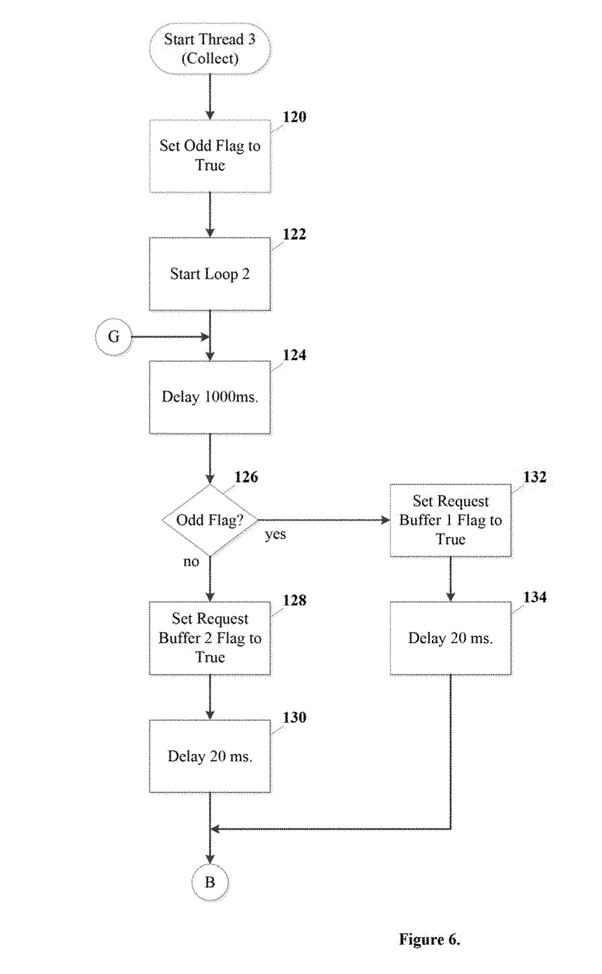

Start Thread 3 (Collect) as shown in FIG. 6 begins with Set Odd Flag to True 120. Next, Loop 2 122 is initiated and followed by Delay 1000 ms 124. The delay is designed to give the sniffer module 1000 ms to collect packets. In alternative embodiments, the delay time may vary.

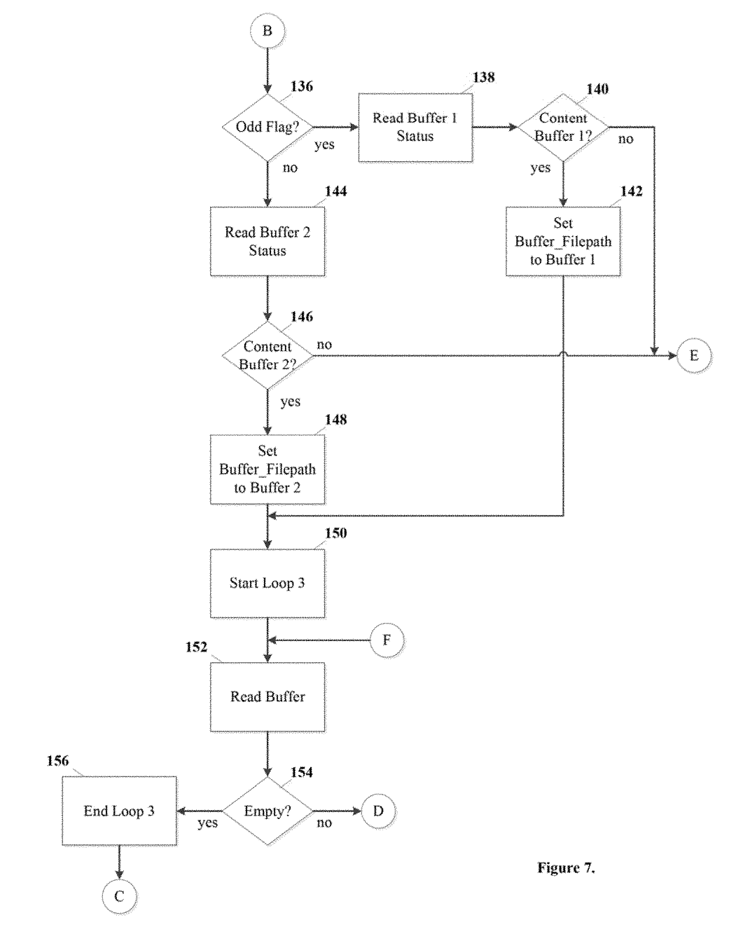

The Delay 1000 ms 124 is followed by a conditional branch called Odd Flag 126 that tests whether the odd flag is set. If odd flag is false. Set Request Buffer 2 Flag to True 128 is executed and the buffer 2 flag is set to true. Then Delay 20 ms 130 is executed. In alternative embodiments, delay may vary. The sequential steps proceed on FIG. 7.

In the event Odd Flag 126 branch is true, then the Set Request Buffer 1 Flag to True 132 and the Delay 20 ms 134 steps are executed. As was mentioned in the previous paragraph, alternative embodiments may have differing delays. The sequential steps proceed to the conditional branch, Odd Flag 136 on FIG. 7.

Referring to FIG. 7, the program continues with a conditional branch test for Odd Flag 136. If Odd Flag is true, then Read Buffer 1 Status 138 is executed. A test of whether there is data in Buffer 1 is made in the conditional branch Content Buffer 1 140. If Content Buffer 1 is true, then the program proceeds to Set Buffer_Filepath to Buffer 1 142 and then on to Start Loop 3 150.

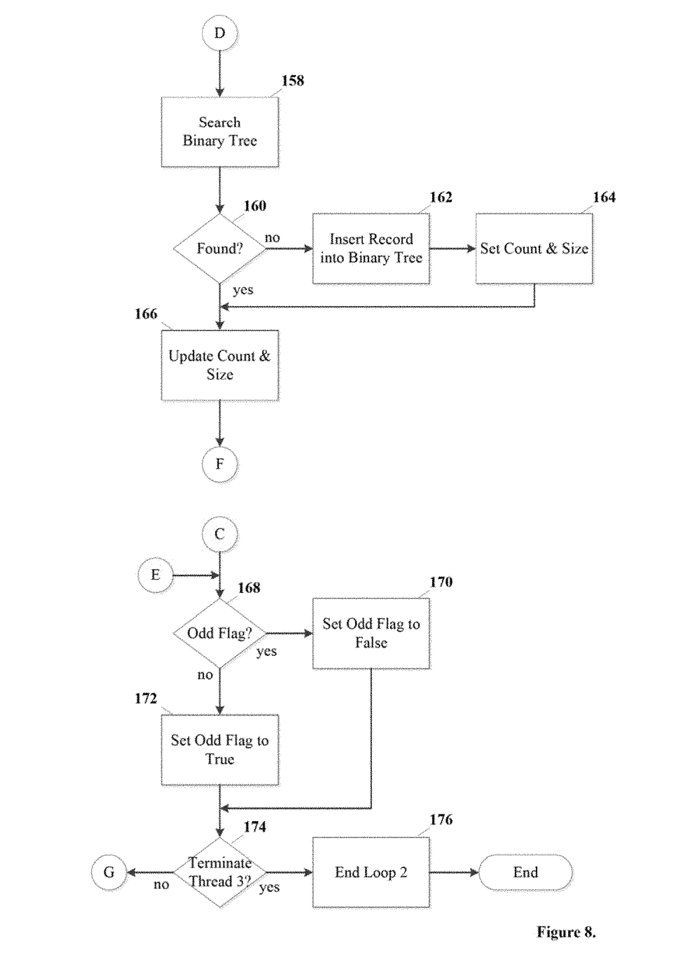

If Content Buffer 1 140 is false, then the program proceeds to a conditional branch, Odd Flag 168, shown in FIG. 8.

Alternative implementations might use alternative buffers to disk drives that are located in RAM or other storage device.

If the conditional branch, Odd Flag 136, is false, then Read Buffer 2 Status 144 is executed. Then the status Buffer 2 is read and evaluated by a conditional branch, Content Buffer 2 146. If Content Buffer 2 Flag is false, the program proceeds to a conditional branch, Odd Flag 168, shown in FIG. 8.

If the Content Buffer 2 146 is true, then the program proceeds to Set Buffer_Filepath to Buffer 2 148, which sets the filepath to the disk buffer. Alternative implementations might use alternative buffers to disk drives that are located in RAM or other storage device. Next, the program proceeds to Start Loop 3 150.

Start Loop 3 150 initiates a code sequence to read the buffer, check a binary tree data structure, and update the structure. After Start Loop 3 150, the Read Buffer 152 step reads the buffer defined by the filepath from either Set Buffer_Filepath to Buffer 1 142 or Set Buffer_Filepath to Buffer 2 148 depending on a number of conditional branches.

If the Buffer contains data as determined by the conditional branch statement Empty 154, the program proceeds to FIG. 8's Search Binary Tree 158. In this step, the Internet Protocol source and destination address pair is extracted and then formed into an IP_Multiple value through the concatenation of source and destination addresses. Finally, a search in the binary tree for the IP_Multiple is conducted before proceeding to the Found 160 conditional statement.

If the Buffer containing data is empty as determined by the conditional branch statement Empty 154, Loop 3 is terminated in the step End Loop 3 156. The program then proceeds to the conditional branch, Odd Flag 168 shown in FIG. 8.

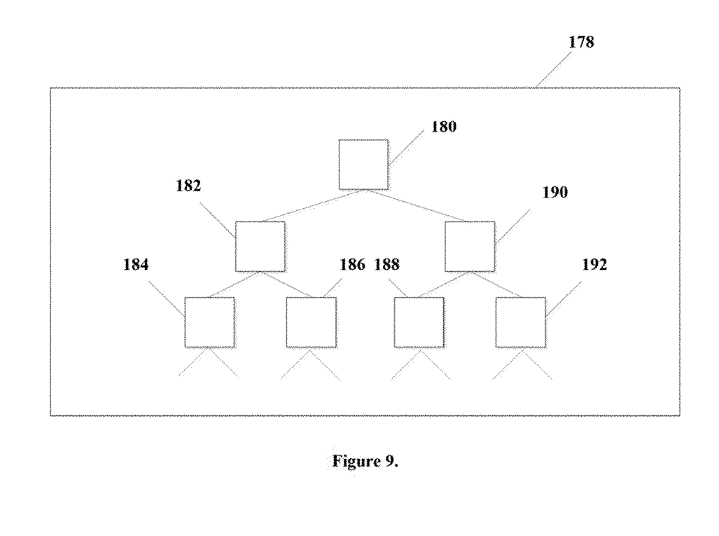

The structure of the Binary Tree 178 is shown in FIG. 9. The Binary Tree, a data structure, contains data containers 180, 182, 184, 186, 188, 190, and 192, connected via address pointers. Each container stores a searchable key, which in this case is the IP_Multiple. The choice of Binary Trees in this embodiment is based on the speed of search.

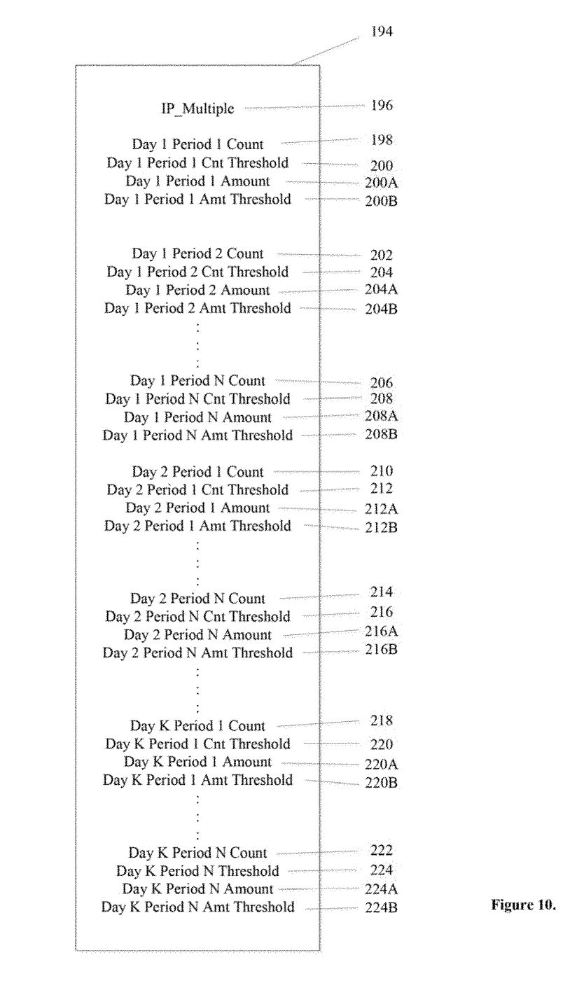

An example Container 194 is shown in FIG. 10. Each Container stores a searchable key, in an embodiment, IP_Multiple 196, as well as Day 1 Period 1 Count 198, Day 1 Period 1 Cnt Threshold 200, Day 1 Period 1 Amount 200A, Day 1 Period 1 AMT Threshold 200B, Day 1 Period 2 Count 202, Day 1 Period 2 Cnt Threshold 204, Day 1 Period 2 Amount 204A, Day 1 Period 2 Amt Threshold 204B, additional N periods for Counts, Amounts, and Thresholds during a day 206 208 208A 208B, Day 2 Period 1 Count 210, Day 2 Period 1 Cnt Threshold 212, Day 2 Period 1 Amount 212A, Day 2 Period 1 Amt Threshold 212B, and additional N periods of Counts, Amounts, and Thresholds during a day 214 216 216A 216B, Day K Period 1 Count 218, Day K Period 1 Cnt Threshold 220, Day K Period 1 Amount 220A, Day k Period 1 Amt Threshold 220B, aid additional Day K Period N Count 222 and Day K Period N Threshold 224, Day K Period N Amount 224A, and Day K Period N Amt Threshold 224B. The Day Period Count is the frequency the IP_Multiple was observed in the period. An alert is triggered if the Day Period Count exceeds the Day Period Threshold during the period and/or if the Day Period Amount exceeds the Day Period Amt Threshold.

Alternative embodiments include other data structures such as arrays, link lists, files, and databases to name a few. In addition, alternative embodiments may contain Containers with varying day and period structures to those shown in the Container 194. The conditional statement, Found 160, tests whether the IP_Multiple was located in the Binary Tree 190. In the event IP Multiple was not found in the Tree, Insert Record into Binary Tree 162 is executed followed by Set Count & Size 164. Update Count & Size 164 increments the count for a specific day and time bin as determined by the segmentation found in a Container 194. For the instance when IP Multiple is not found in the Tree, the Count after the record is inserted during the step Insert Record into Binary Tree 162, updated to 1 in the step Update Count 164.

If the conditional statement, Found 160, is false, then Update Count 166 is executed and the count in the corresponding day and period incremented by one. The program then returns to the beginning of Loop 3 150 shown on FIG. 7 and the loop is repeated.

If the conditional branch, Empty 154, is true, Loop 3 is terminated in End Loop 3 156. This happens when the Read Buffer 152 doesn't contain data. The program then proceeds to a conditional branch called Odd Flag 168 in FIG. 8.

The conditional branch, Odd Flag 168 determines if Loop 3 is on an even or odd count as defined by the state of an Odd Flag which is initially set to true in Set Odd Flag to True 120. If Odd Flag 168 is true, then Set Odd Flag to False 170 is set to False before proceeding to the conditional branch Terminate Thread 3 174.

If Odd Flag 168 is false, then Set Odd Flag to True 172 is executed before proceeding to the conditional branch Terminate Thread 3 174 as shown in FIG. 6.

Terminate Thread 3 checks whether the terminate thread 3 flag was set in Set Terminate Flags for Threads 2 & 3 60. If the Terminate Thread 3 Flag is set, then End Loop 2 176 is executed and Thread 3 ends.

If the Terminate Thread 3 Flag is not set, then Loop 2 is repeated starting with Delay 1000 ms 124.

Thread 4 is a collection of steps associated with analyzing the counts stored in the Binary Tree. Using this step, the user can assess the frequency of network communication, day, and time period, as well as which computers are exchanging information. Based on the analysis, thresholds for alerting the network administrator or other appropriate user can be set based on rules concerning activity count. In the described embodiment, thresholds are computed using a database as a cache for binary tree data. Alternative embodiments may calculate the threshold without the reliance on a database. These non-database alternatives include in-memory approaches or file based solutions.

Thread 4 starts begins with the step, Open Database Connection 226. This step is followed by Get First Binary Tree Container Location 228, which get the first location of the Container in the Binary Tree. Loop 4 230 is started and the values of the First Container are read in the step Read Binary Tree Container Values 232. The values are then inserted into a database table in the step insert Values Into to Database Table T1. A conditional branch, Done Reading Tree 236, is executed to determine if the end of the Binary Tree has been reached. If the end of the Binary Tree has not been reached, the program steps to the next Container in Step to Next Binary Tree Container 238. Then the program proceeds to repeat Loop 4 by executing Read Binary Tree Container Values 232 next.

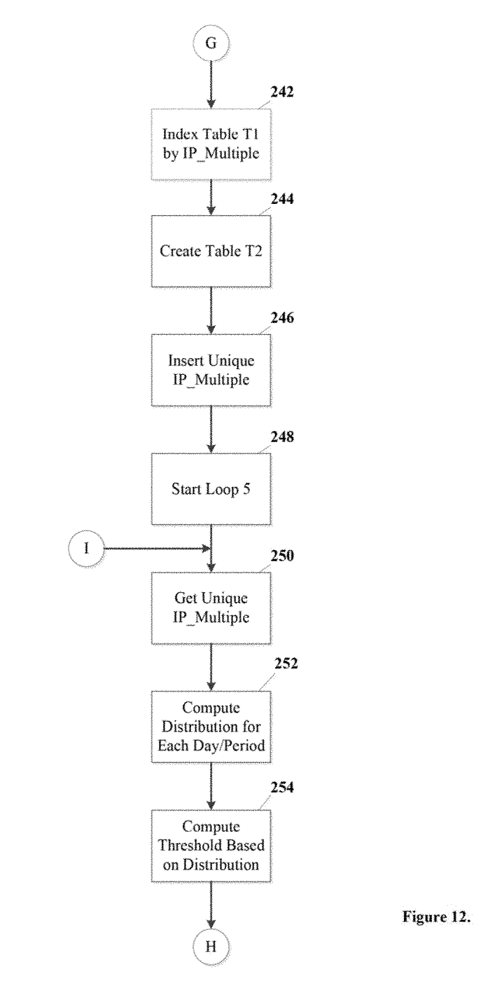

If conditional branch, Done Reading Tree 236 is true, the Loop 4 is terminated in End Loop 4 240. End Loop 4 240 is followed by the step Index Table T1 by IP_Multiple 242 shown in FIG. 12. This step causes table T1 to be indexed for faster queries. The IP_Multiple is the primary key for T1. The next step, Create Table T2 244, creates a table to hold unique IP_Multiple instances. This step is followed by Insert Unique IP_Multiple 246, which consists of inserting the unique IP_Multiple instances into table T2.

Loop 5 reads unique IP_Multiple values from table T2, queries and computes the distribution for each period within a day, or whatever Container segmentation is used, and then computes a threshold based on the distribution and rules provided by the user. The threshold is inserted into table T1 as well as the Binary Tree.

Loop 5 begins with the step Start Loop 5 248. This step is followed by Get Unique IP_Multiple 250 where the unique IP_Multiples are harvested from table T1. For each Unique IP_Multiple, a query is made of table T1 and the distribution compute for each period in step Compute Distribution for Each Day/Period 252. Based on the computed distribution, a threshold is assigned to each Container segment in the step Compute Threshold Based on Distribution 254. Table T1 and the thresholds in the Binary Tree updated in steps Update Table T1 256 and Update Thresholds in Binary Tree 258.

A conditional branch, Done Reading Table T2 260, follows Update Thresholds in Binary Tree 258. If table T2 is without further records, Thread 4 is terminated. If table T2 has remaining records, the Binary Tree is incremented in step Increment Binary Tree 262. Then Loop 5 is repeated beginning with the step Get Unique IP_Multiple 250.

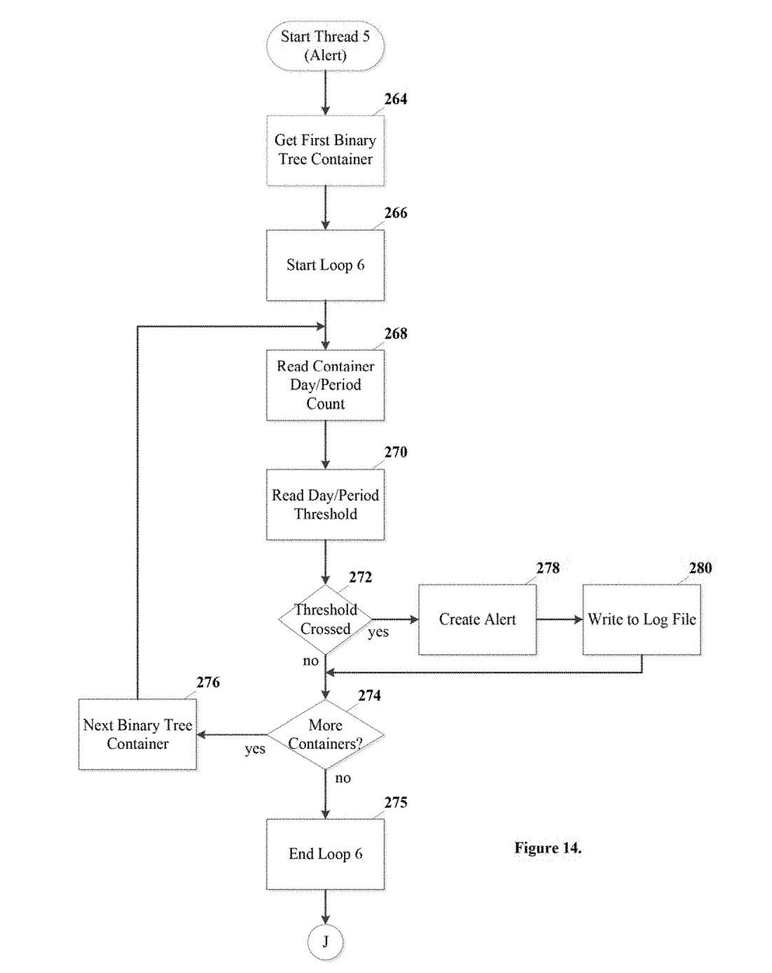

Referring to FIG. 14, thread 5 pertains to the storing alerts in a database and deciding what alerts should be sent to the user. Thread 5 begins with the step Get First Binary Tree Container 264 and is followed by the initiation of Loop 6 in the step Start Loop 6 266. Next, the count for each segment is read in the step Read Container Day/Period Count 268 followed by the step Read Day/Period Threshold 270. The count and threshold is compared in the conditional branch, Threshold Crossed 272. If the Threshold Crossed 272 is true, then an alert is created in Create Alert 278 and is written to a log file in the step Write to Log File 280. The program proceeds to the conditional branch More Containers 274.

If the conditional branch, Threshold Crossed 272, is false, the program proceeds to the conditional branch More Containers 274.

The conditional branch, More Containers 274, determines whether there are unread Containers in the Binary Tree. If More Containers 274 is true, then the next Container is selected in Next Binary Tree Container 276 and Loop 6 repeated starting with Read Container Day/Period Count 268.

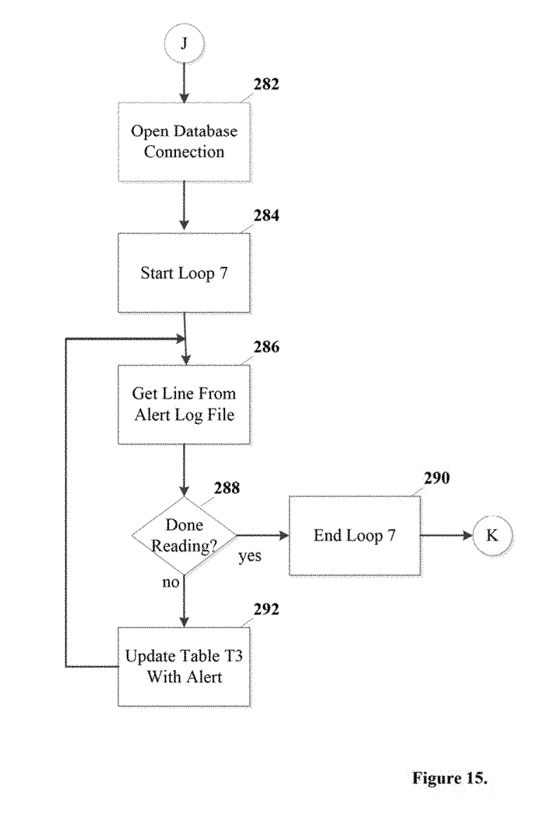

If More Containers 274 is false, Loop 6 is terminated in the step End Loop 6 275. Then Open Database Connection 282 establishes a connection to the database. See FIG. 15.

Loop 7 is started in the step Start Loop 7 284. A line containing an Alert is read from the Log File in the step Get Line From Alert Log File 286. A conditional branch, Done Reading 288, tests whether there the step Get Line From Alert Log File 286 retrieved a record.

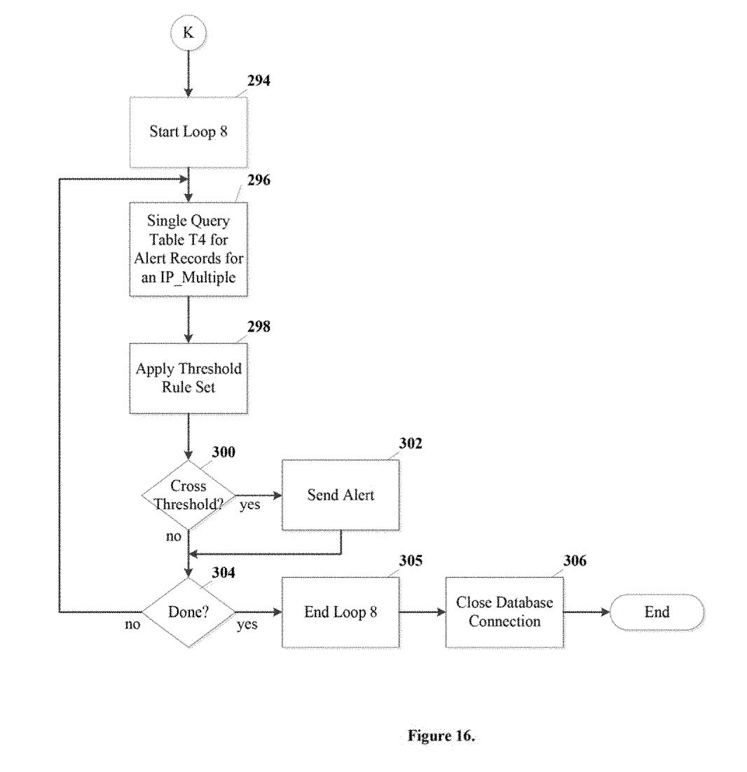

If Done Reading 288 is false, then table T3 Is updated with the alert in the step Update Table T3 with Alert 292. If Done Reading 288 produces a true, Loop 7 is terminated in the step End Loop 6 290 and the program proceeds to Start Loop 8 294 in FIG. 16.

Loop 8 shown in FIG. 16 pertains to determining which Alerts to send to the user or Network Administrator. Loop 8 begins with Start Loop 8 294. Next, Single Query Table T4 for Alert Records for an IP_Multiple 296 is made. A predefined rule set defines the alert thresholds that are to be used in Apply Threshold Rule Set 298. If conditional branch, Cross Threshold 300, is true, then an alert is sent in step Send Alert 302, then the program proceeds to test whether Loop 6 is finished in the step Done 304.

If Cross Threshold 300 is false, the program proceeds to test whether Loop 6 is finished in the step Done 304.

If the conditional branch, Done 304, is true, then Loop 8 is terminated in the step End Loop 8 305, the database connection is closed in the step Close Database Connection 306, and Thread 5 is terminated. If Done 304 is false. Loop 8 is repeated starting with Single Query Table T4 for Alert Records for an IP_Multiple 296.

The present invention offers advantages over prior art. These advantages include, but are not limited to, the following;
1. Malware signatures are not required to detect a potential network attack. Instead, a statistical method is employed which allows for detection previously unknown malware.
2. Not installing the present invention on every computer In the network. The invention is designed to be installed at a network node which will provide benefit to those computers connected to the node.
3. Not limiting the speed of the network. The present invention is not an active part of the network and only passively monitors network traffic.
4. Detecting potential nefarious behavior of an employee or individual with network access who is maliciously transferring files.

In the foregoing specification, the invention has been described with reference to the specific embodiments thereof. However, the scope of the claims should not be limited by the preferred embodiments set forth in the examples, but should be given the broadest interpretation consistent with the description as a whole. The specification and drawings are, accordingly, to be regarded in an illustrative rather than a restrictive sense.

I claim:

1. A computer program product embodied on a computer readable medium for utilizing network activity in determining a potential attack, comprising;
computer code for monitoring computer network traffic activity, via a connection to the computer network, utilizing a processor of a computer system, wherein the frequency of source and destination Internet Protocol address pairs are recorded by time interval, and
computer code for generating alerts based on frequency threshold crossings for specific source and destination Internet Protocol addresses, and
computer code for generating alerts based on the amount threshold crossing for the quantity of data associated with each specific source and destination Internet Protocol address, and
computer code to alert the user,
computer code to alert other network devices used to selectively terminate the further exchange of data between Internet Protocol address pairs,
wherein the computer code is executed utilizing the processor for aiding in the determination of the potential attack.

2. A system for utilizing a frequency and amount of data exchanged of source and destination Internet Protocol address pairs, comprising;
a processor for monitoring Internet Protocol traffic on a network via a network connection, calculating a first threshold for frequency and a second threshold for the amount of data exchanged for specific source and destination Internet Protocol address pairs, setting a frequency threshold and a size threshold for specific source and destination Internet Protocol address pairs by time period, generating alerts when the frequency crosses the frequency threshold or the data exchanged crosses the amount of data exchanged threshold, and
an output device coupled to the processor, the output device outputting the alert;
wherein the computer code is executed utilizing the processor for aiding in the achievement of identifying potential network attacks.

3. A system as recited in claim 2, wherein the frequency of source and destination Internet Protocol addresses is used to estimate the behavior computer to computer communications.

4. A system as recited in claim 2, wherein the frequency of the source and destination Internet Protocol addresses is used to compute a frequency distribution of computer to computer communications.

5. A system as recited in claim 2, wherein the frequency of the source and destination Internet Protocol addresses is used to calculate an expected probability of frequency in a given period.

6. A system as recited in claim 2, wherein a frequency threshold for a specific source and destination Internet Protocol address can be set.

7. A system as recited in claim 5, wherein the frequency threshold for a specific source and destination Internet Protocol address is set using the expected probability of frequency.

8. A system as recited in claim 2, wherein an observed frequency for a specific source and destination Internet Protocol address is compared with the frequency threshold.

9. A system as recited in claim 8, wherein an alert is generated when the frequency threshold is exceeded by the observed frequency for a specific source and destination Internet Protocol address.

10. A system as recited in claim 2, wherein the amount of data exchanged for source and destination Internet Protocol addresses is used to estimate the behavior of computer to computer communications.

11. A system as recited in claim 2, wherein the amount of data exchanged for source and destination Internet Protocol addresses is used to compute a data exchange distribution of computer to computer communications.

12. A system as recited in claim 2, wherein the amount of data exchanged for source and destination Internet Protocol addresses is used to calculate an expected probability of data exchanged in a given period.

13. A system as recited in claim 2, wherein a data exchange threshold for a specific source and destination Internet Protocol address can be set.

14. A system as recited in claim 2, wherein the frequency threshold for a specific source and destination Internet Protocol address is set using the expected probability of data exchange.

15. A system as recited in claim 2, wherein an observed data exchange for a specific source and destination Internet Protocol address is compared with the data exchange threshold.

16. A system as recited in claim 15, wherein an alert is generated when the frequency threshold is exceeded by the observed data exchange for a specific source and destination Internet Protocol address.

17. A system as recited in claim 2, wherein alerts are aggregated

18. A system as recited in claim 17, wherein user alerts are sent based on aggregated alerts
